(19) United States
(12) Patent Application Publication
(10) Pub. No.: US 2009/0119312 A1
(43) Pub. Date: May 7, 2009

(54) Taxonomy tool

(75) Inventors: Campbell Pryde, New York, NY (US); Walter Phillip Engel, Studio City, CA (US); Maureen Murphy, Brooklyn, NY (US); Monika Nica, Forest Hills, NY (US); Ryan Doherty, New York, NY (US)

Correspondence Address: K&L GATES LLP, 535 SMITHFIELD STREET, PITTSBURGH, PA, 15222, US

(73) Assignee: Morgan Stanley, New York, NY (US)

(21) Appl. No.: 11/982,269

(22) Filed: Nov. 1, 2007

(51) Int. Cl. G06F 17/30

(52) U.S. Cl. 707/100; 707/E17.002

(57) ABSTRACT

In one general aspect, the present disclosure is directed to a system for describing information. This system may comprise at least one processor. The at least one processor may be configured to receive a taxonomy that may comprising a metric hierarchy and a plurality of entity hierarchies. The at least one processor may also be configured to display an indication of a metric selected from the metric hierarchy. In addition, the at least one processor may be configured to display a representation of at least a portion of a second hierarchy selected from the plurality of entity hierarchies. The representation may comprise an indication of a branch of the second hierarchy and an indication of a relationship between the branch of the second hierarchy and the metric.

### STATEMENT REGARDING COLOR DRAWINGS

The patent or application file contains at least one drawing executed in color. Copies of this patent or application publication with color drawings will be provided by the Office upon request and payment of the necessary fee.

### BACKGROUND

The present disclosure relates to taxonomies and tools for creating modifying and/or displaying taxonomies.

### SUMMARY

In one general aspect, the present disclosure is directed to a system for describing information. This system may comprise at least one processor. The at least one processor may be configured to receive a taxonomy that may comprising a metric hierarchy and a plurality of entity hierarchies. The at least one processor may also be configured to display an indication of a metric selected from the metric hierarchy. In addition, the at least one processor may be configured to display a representation of at least a portion of a second hierarchy selected from the plurality of entity hierarchies. The representation may comprise an indication of a branch of the second hierarchy and an indication of a relationship between the branch of the second hierarchy and the metric.

In another general aspect, the present disclosure is directed to a system for describing information comprising at least one processor. The at least one processor may be configured to receive a taxonomy. The taxonomy may comprise a plurality of hierarchies. The at least one processor may also be configured to tie a first branch selected from a first hierarchy to a second branch selected from the second hierarchy. The first and second hierarchies may be selected from the plurality of hierarchies. In addition, the at least one processor may be configured to receive an instruction to modify a portion of the first branch, modify the portion of the first branch in response to the instruction, and modify a duplicate of the portion of the first branch within the second branch in response to the instruction.

In yet another general aspect, the present disclosure is directed to a system for describing information comprising at least one processor. The at least one processor may be configured to receive a taxonomy comprising a first hierarchy and a second hierarchy. The first hierarchy may comprise concepts of a first concept type and the second hierarchy may comprise concepts of a second concept type. The at least one processor may also be configured to display an indication of a first concept selected from the first hierarchy, and display a representation of at least a portion of a second hierarchy. The representation may comprise an indication of a branch of the second hierarchy and an indication of a relationship between the branch of the second hierarchy and the first concept.

### FIGURES

Embodiments of the present invention are described herein, by way of example, in conjunction with the following figures, wherein:

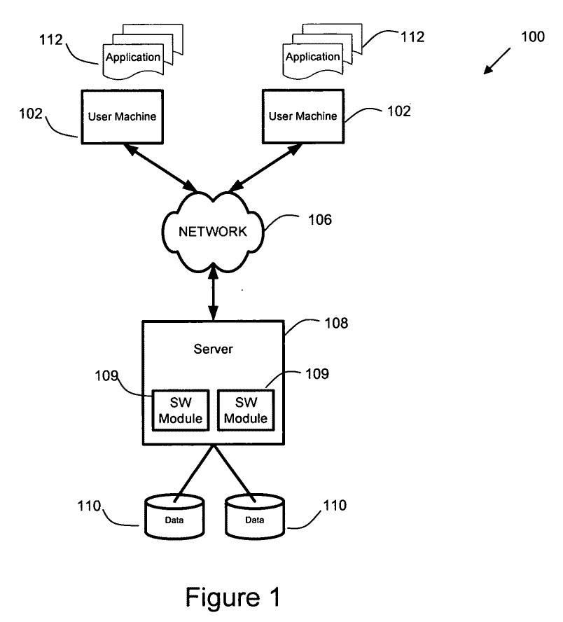

FIG. 1 illustrates one embodiment of a computer system for utilizing a taxonomy;

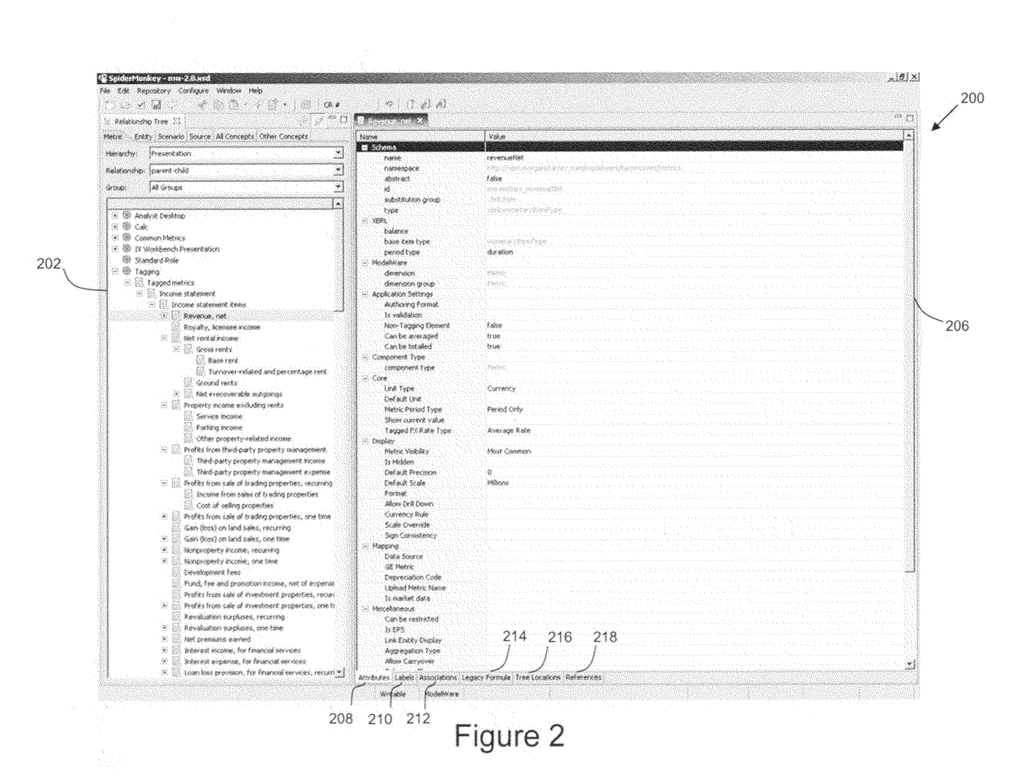

FIG. 2 illustrates one embodiment of a user interface that may be displayed to an administrator user;

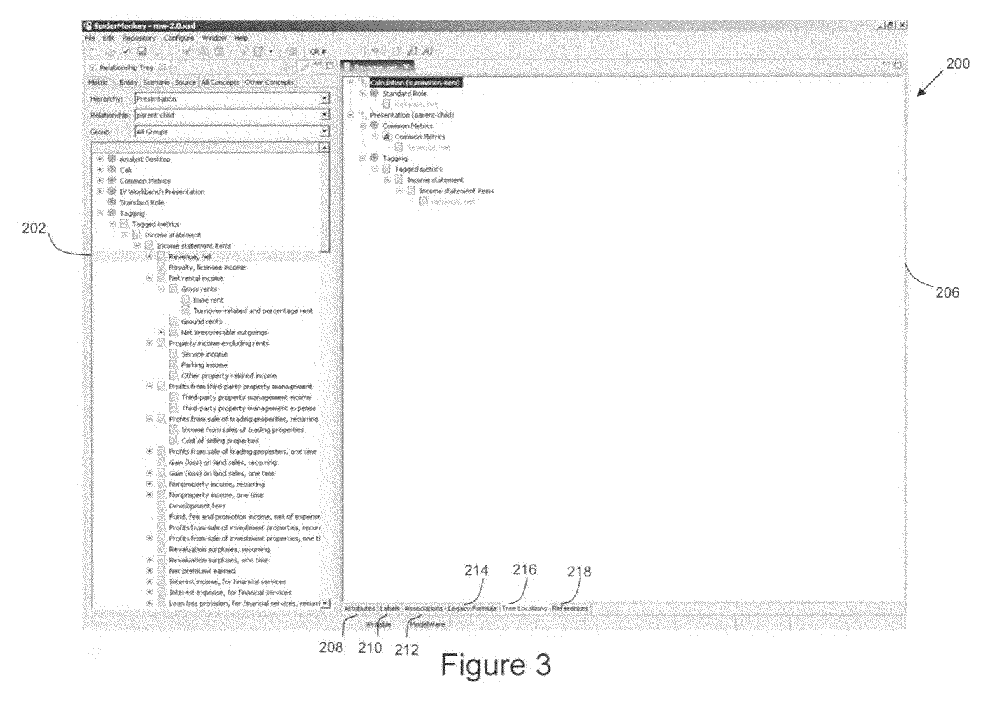

FIG. 3 illustrates one embodiment of the user interface of FIG. 2 with a “Tree Locations” tab selected;

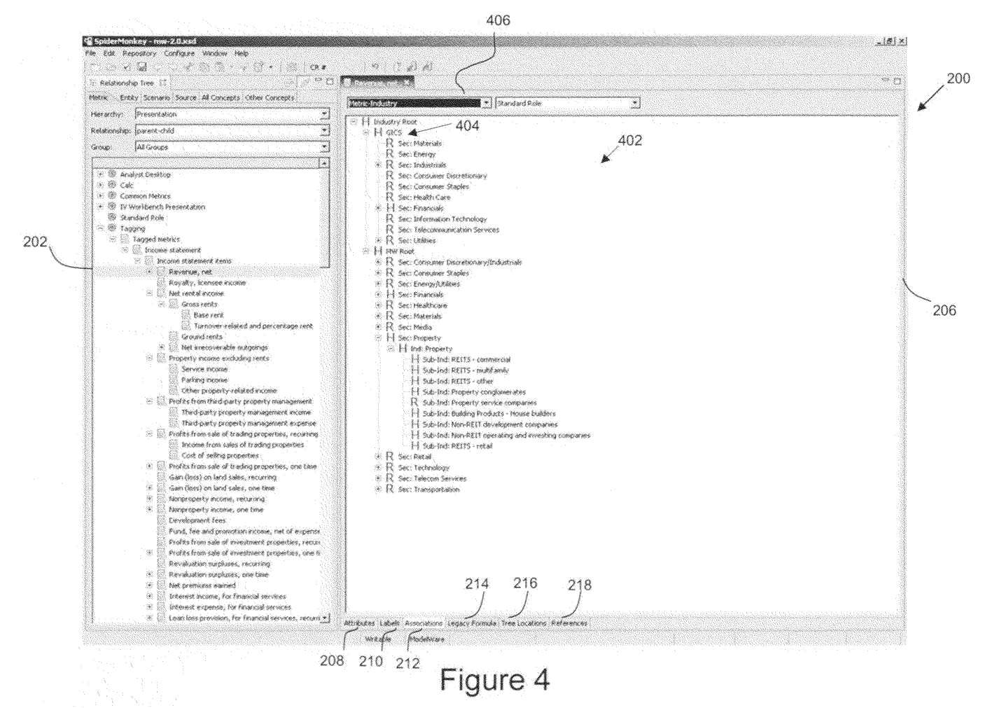

FIG. 4 illustrates one embodiment of the user interface of FIG. 2 with an “Associations” tab selected;

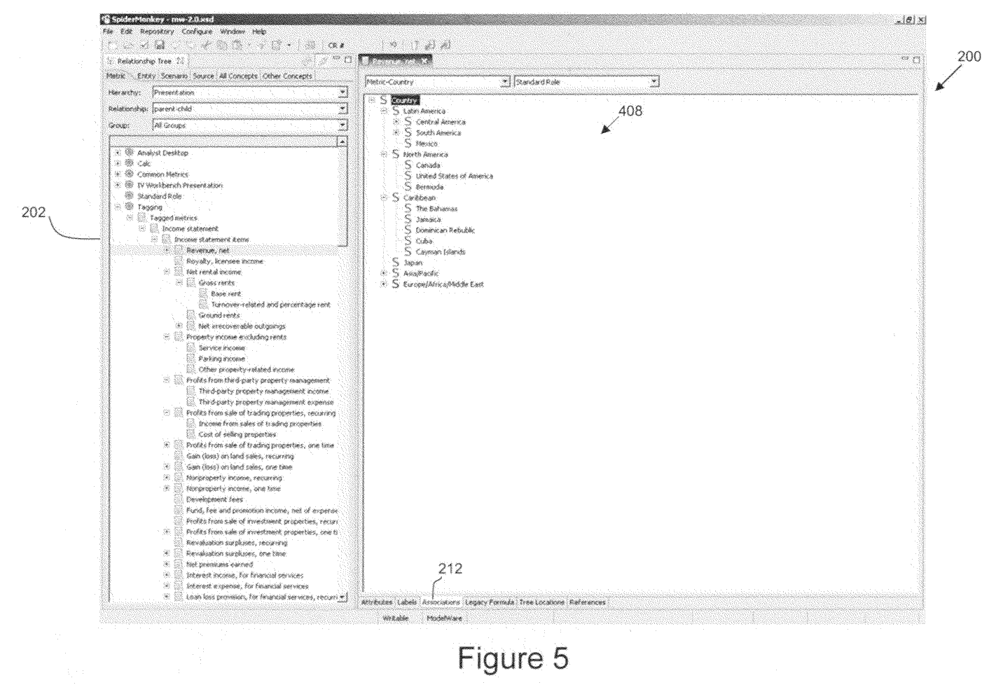

FIG. 5 illustrates one embodiment of the user interface of FIG. 2 configured to show the relationships between a selected metric and a hierarchy of geographic-type entities;

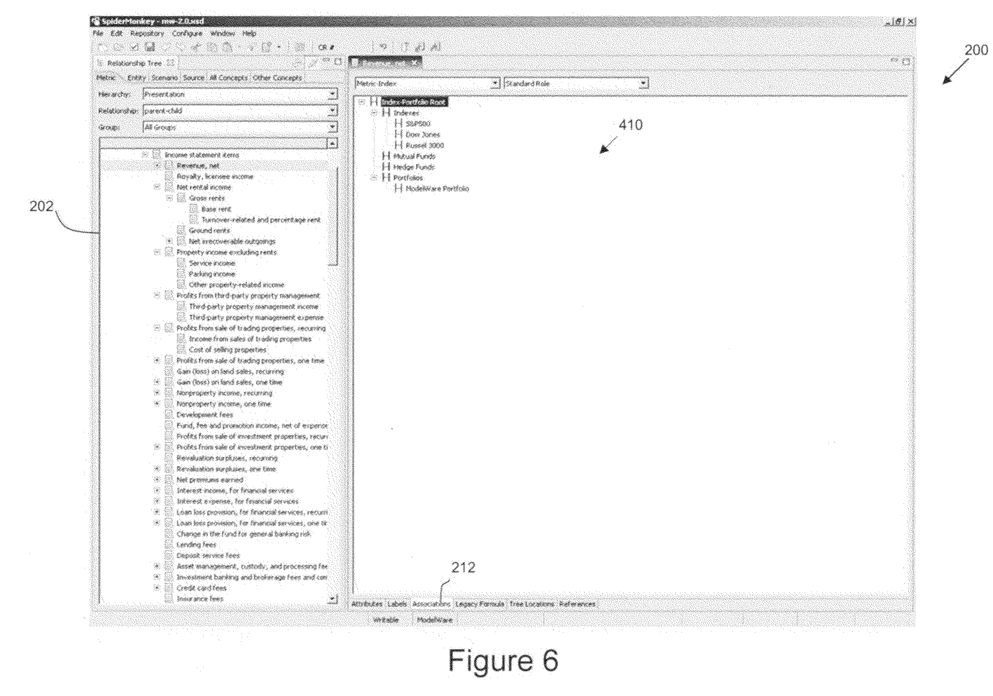

FIG. 6 illustrates one embodiment of the user interface of FIG. 2 configured to show relationships between a selected metric and a hierarchy of indices and portfolios;

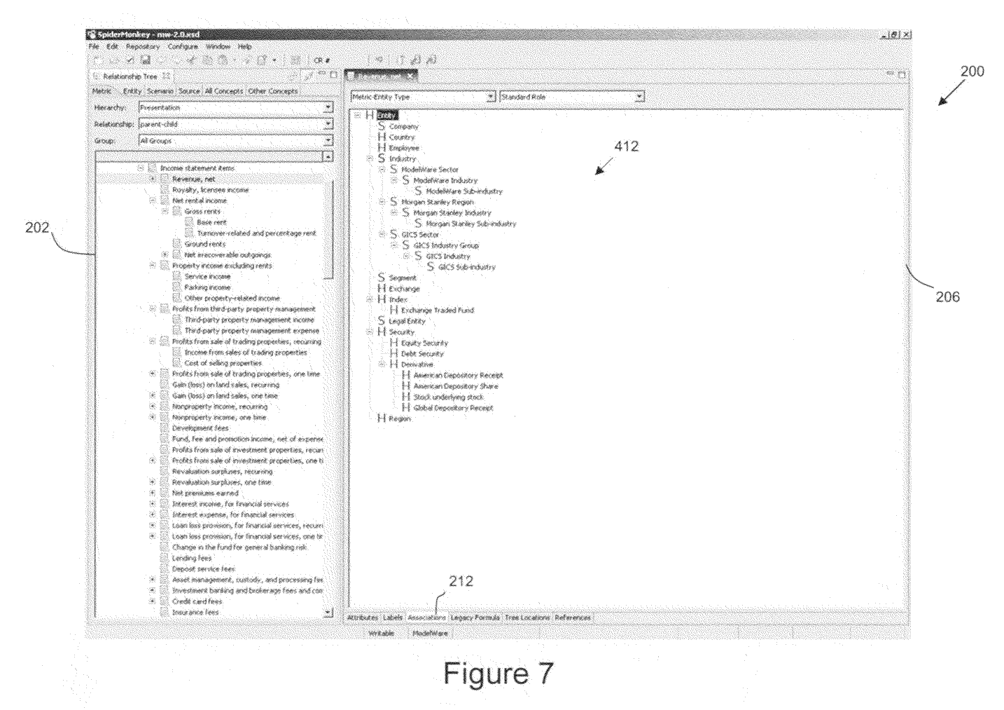

FIG. 7 illustrates one embodiment of the user interface of FIG. 2 configured to show relationships between a selected metric and a hierarchy of different entity types;

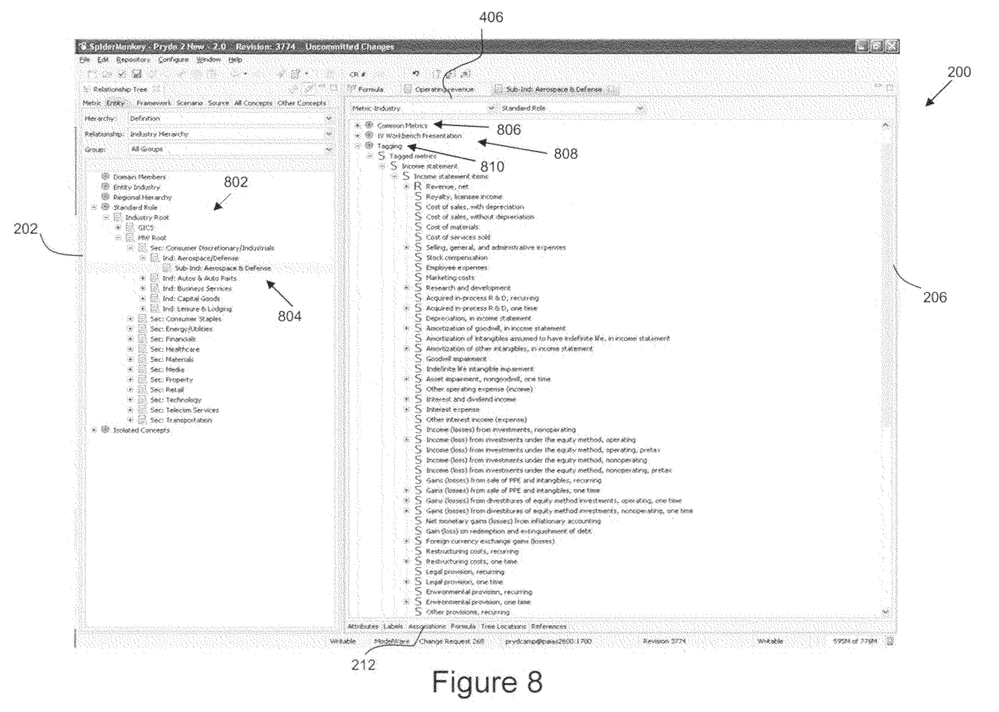

FIG. 8 illustrates one embodiment of the user interface of FIG. 2 configured to display relationships between entity concepts and metric concepts; and

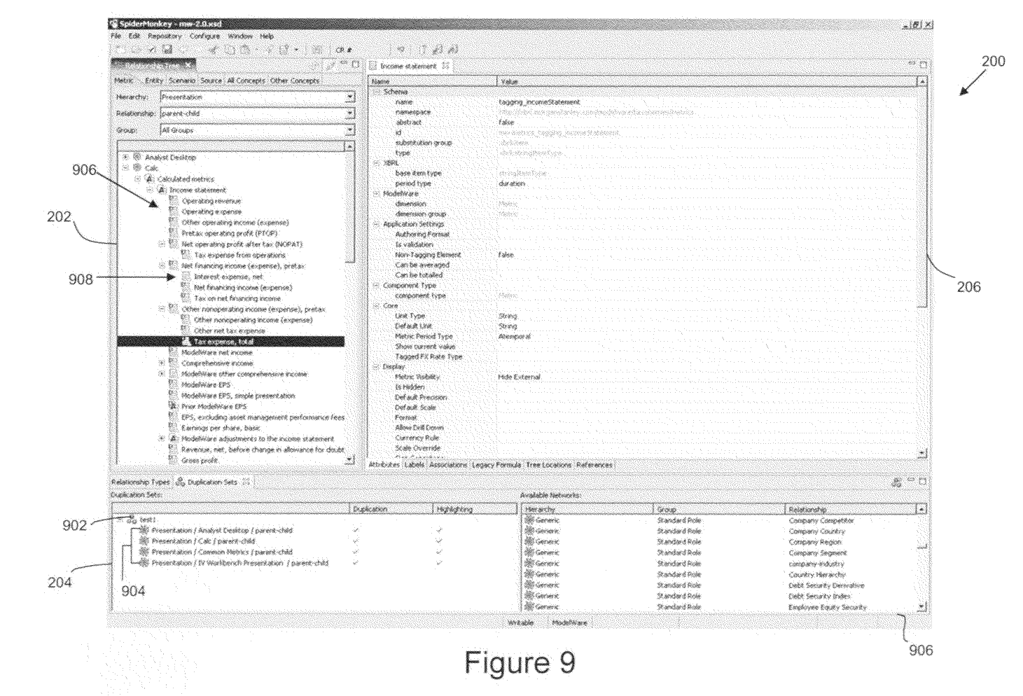

FIG. 9 illustrates one embodiment of the user interface of FIG. 2 including a window for creating and/or displaying duplication sets.

### DESCRIPTION

A taxonomy may be a framework for describing and/or classifying information. For example, a taxonomy may describe associations between various concepts including, for example, metrics and entities. An entity may be any kind of tangible or intangible concept or object. A metric may be any kind of descriptor that describes an entity. Other concept types may include, for example, information/data sources and time-based concepts such as dates, times, periods, etc. In one embodiment, taxonomies may be used to describe the financial properties of various business and/or political entities. Example metrics in this context may include financial descriptors, such as gross domestic product, adjusted gross income, liabilities, etc. Example entities may include individuals, business units, countries, geographic regions, objects, and various divisions and sub-divisions thereof. Taxonomies may also be used in other contexts. For example, taxonomies may be used to relate operational information to industries, such as oil production, energy company statistics, environmental reporting, etc.

Taxonomies may be used by organizations or groups of users to facilitate the common expression of information. For example, in a computer network setting, one or more taxonomies may be utilized to ensure common metric and entity definitions between different applications and/or different users. According to various embodiments, a single taxonomy may be used to describe multiple concept types (e.g., metrics, entities, sources, etc.). One example of such a taxonomy may include a plurality of metrics and a plurality of entities. The taxonomy may also include associations between various metrics and the entities that they may describe. Stated another way, the associations may be created between various entities and the metrics that may describe it. In this way, the taxonomy may include large numbers of metrics and entities without cluttering the description of any given entity with non-applicable metrics. When a taxonomy includes other concepts types in addition to or instead of metrics and entities, it may also include associations between some or all of the various concepts.

In accordance with various embodiments, the concepts of a taxonomy may be organized into hierarchies. One or more metric hierarchies may arrange different metrics hierarchically based on their definition, type, etc. For example, in one kind of metric hierarchy, each metric may have its components and subcomponents positioned below it. For example, a metric “Net rental income” may be a function of the metrics “Gross rents”, “Ground rents” and “Net irrecoverable outgoings.” Accordingly, the metrics, “Gross rents”, “Ground rents” and “Net irrecoverable outgoings” may be positioned below the metric “Net rental income” in the hierarchy. Other metric hierarchies may arrange metrics according to various other parameters including, for example, frequency of use, and roles. A taxonomy may also include a plurality of entity hierarchies. Each entity hierarchy may include entities of a similar type arranged according to any suitable configuration. For example, a hierarchy of industry-type entities may include entities such as materials, energy, industrials, consumer discretionary, etc., and sub-divisions thereof. A hierarchy of country-type entities may include entities such as Latin America, North American, Europe, etc., and sub-divisions thereof. Other concept types may also be organized into hierarchies.

FIG. 1 illustrates one embodiment of a computer system 100 for utilizing one or more common taxonomies. The system 100 may include a server 108 and one or more user machines 102 in communication with one another via a network 106. Users of the system 100 may be able to utilize the functionality of various applications 112, which may be executed by a user machine 102 and/or the server 108. The applications 112 may enable the users to perform various tasks including, modeling entities, monitoring the status of entities, uploading data regarding entities, etc. For example, the applications 112 may include any kind of application that may be used to compare concepts across companies or entities, or to analyze individual companies or individual entities. For example, the applications 112 may include spreadsheet applications, word processing applications, custom modeling applications, etc.

The network 100 may also be used to administer a common taxonomy or taxonomies, for example, by creating or modifying taxonomies. Data regarding taxonomies may be stored at databases 110. Also, the server 108 may include one or more software modules 109 having functionality for creating and/or modifying a taxonomy. A user may access this functionality, for example, by logging-in to the server 108 and/or through a user machine 102. According to various embodiments, taxonomy administration may be performed only by a predetermined class of user (e.g., administrator, power user, etc.). The class of any given user may be verified according to any suitable method.

FIG. 2 illustrates one embodiment of a user interface 200 that may be displayed to a user to facilitate creating or modifying a common taxonomy. The interface 200 may include a window 202 illustrating a subject concept, and a window 206 displaying data regarding the subject concept. As shown in FIG. 2, window 202 illustrates a metric hierarchy. Branches of the metric hierarchy may be hidden or displayed according to any suitable method, including, for example, by selecting the respective “minus” or “plus” signs illustrated. Selecting a given metric in the window 202 may cause additional information about the selected metric to display at window 206. For example, in FIG. 2, the metric “Revenue, net” has been selected. In accordance with one embodiment, a user may choose which information about the selected metric is shown at window 206, for example, by selecting one or more of tabs 208, 210, 212, 214, 216, 218. When the Attributes tab 208 is selected, as shown in FIG. 2, the window 206 may display various attributes of the selected metric. Likewise, selecting the Labels tab 210 may cause the window 206 to display various names and aliases of the selected metric. Selecting the Legacy Formula tab 214 may cause the window 206 to show the definition of the selected metric, for example, in terms of other metrics. Selecting the References tab 218 may cause the window 206 to display references related to the metric. In this way, the interface 200 may list, or link to resources and references that explain the metric, but may not be completely reproduced. Example references that may be listed or linked to may include, for example, laws and regulations defining or otherwise relating to the metric, descriptions of the metric in a dictionary or other source, guidelines explaining the metric and methods of calculating it, etc.

FIG. 3 illustrates one embodiment of the user interface 200 with a “Tree Locations” tab 216 selected. Selecting the “Tree Locations” tab 216 may cause the window 206 to display the position of the selected metric within one or more metric hierarchies. For example, in the taxonomy illustrated by the interface 200, the metric, “Revenue, net” is shown to be a part of a “Calculation” metric hierarchy, a “Presentation” metric hierarchy and a “Tagging” metric hierarchy. These, and other different hierarchies may be used to represent metrics and entities in a form useful to different downstream applications 112. For example, the “Calculation” metric hierarchy may organize metrics to describe how values for the metrics are calculated. The “Presentation” hierarchy may organize metrics to describe how the metrics and/or the hierarchy may be displayed. Different applications 112 may use each hierarchy in different ways.

FIG. 4 illustrates one embodiment of the user interface 200 with an “Associations” tab 212 selected. When the tab 212 is selected, it may cause the window 206 to display associations between the selected metric and entities that may be described by the selected metric. For example, as shown in FIG. 4, the window 206 shows a representation of an entity hierarchy 402 including industry-type entities. The hierarchy 402 and its various branches may be displayed or hidden, for example, by selecting the plus and minus signs, or according to any other suitable method. According to various embodiment, the hierarchy 402 may include industries, sub-industries, sectors, companies, etc., and sub-divisions thereof.

Each entity branch and sub-branch of the hierarchy 402 may include an indication of a relationship between the corresponding entity or entities and the selected metric. For example, the materials sector entity (Sec: Materials) includes an indication 404 of the letter “R”, which may mean that each entity classified under the materials sector is required to have an associated value for “Revenue, net”. It will be appreciated, however, that any other suitable indications may be used. Other branches and/or sub-branches may include an indication that the corresponding entities are permitted to have a value for the selected metric, but are not required to (e.g., “S” for “shown”). Still other branches and/or sub-branches may include an indication that the corresponding entities may not have a value for the selected metric (e.g., “H” for “hidden”).

Because there may be more than one entity hierarchy, the window 206 may be configurable to show different entity hierarchies and the relationships between the entities thereof and the selected metric. For example, the user interface may include a drop-down menu 406 or other selection input field for selecting an entity hierarchy to be displayed. As shown in FIG. 4, the menu 406 is configured to show “Metric-Industry” relationships (e.g., by showing an industry-type entity hierarchy). FIG. 5 illustrates one embodiment of the user interface 200 configured to show the relationships between a selected metric and a hierarchy 408 of geographic-type entities. The hierarchy 408 may include entities including, for example, countries, states or provinces, cities, etc., and subdivisions thereof. FIG. 6 illustrates one embodiment of the user interface 200 configured to show relationships between a selected metric and a hierarchy 410 of indices and portfolios. The hierarchy 410 may include individual indices, index-types, mutual fund and hedge fund classes, individual mutual funds and hedge funds, etc., and subdivisions thereof. FIG. 7 illustrates one embodiment of the user interface 200 configured to show relationships between a selected metric and a hierarchy 412 of different entity types. For example, the hierarchy 412 may include companies, countries, employees, industries, segments, exchanges, etc., and subdivisions thereof. Relationships between various the selected metric and various other concept types (e.g., information/data sources, times, time periods, etc.) may also be displayed.

In accordance with various embodiments, the user interface 200 may also be configured to display information and associations with other concept types. For example, FIG. 8 illustrates one embodiment of the user interface 200 configured to display relationships between entity concepts and metric concepts. An entity hierarchy 802 is shown in window 202. The entity hierarch 802 is shows to be a hierarchy of industries and sub-industries, but any entity hierarchy type could be used. As shown in window 202, the entity 804 entitled, “Sub-Ind: Aerospace & Defense” is selected. This may cause the window 206 to display metrics corresponding to the entity 804. For example, the window 206 may show one or more hierarchies of metrics 806, 808, 810. The hierarchy 810 is shown to be expanded, showing several branches and sub-branches. Each branch or sub-branch may include an indication of its underlying relationship to the selected entity 804 (e.g., “S,” “R,” and/or “H” as described above, or any other suitable indication). According to various embodiments, entity or metric attributes, such as definitions, interrelationships, etc. may be inherited through a hierarchy. For example, when an attribute of a first metric or entity is set, all of the entities and/or metrics under the first metric or entity may receive the same value, unless otherwise specified.

The user interface 200 may be utilized by a user of the system 100 to create and/or modify taxonomies. For example, referring again to FIG. 4, an authorized user may add or delete metrics from the metric hierarchy shown at window 202 or window 206. In one embodiment, the user may also click-and-drag a particular metric to change its location in the hierarchy. Similar changes may be made to an entity hierarchy displayed at window 202 or window 206. In addition, the user may modify the relationship between any given metric and any given entity according to any suitable method. For example, the user may select the indication of the relationship between an entity and a metric and modify it, for example, by selecting a different relationship from a menu.

It will be appreciated that certain some concepts (e.g., metrics, entities, sources, etc.) may be included in more than one hierarchy. For example, as described above, a single metric may be included in a tagging hierarchy, a presentation hierarchy, and/or a calculation hierarchy. Also a single entity, such as a company-entity, may be included in a company hierarchy, an industry hierarchy, etc. According to various embodiments, the system 100 may include functionality for tying two or more hierarchies or portions thereof to create a duplication set. A duplication set may include two or more hierarchies, or portions thereof. Usually, the hierarchies or hierarchy portions included in a duplication set have one or more common branches. After a duplication set is created, changes made to one instance of a common branch may be duplicated across all instance of the common branch within the duplication set. It will be appreciated that a common branch may include a single concept.

FIG. 9 illustrates one embodiment of the user interface 200 including a window 204 for creating and/or displaying duplication sets. A user of the system 100 may provide instructions specifying which hierarchies or portions thereof should be tied into a duplication set. For example, if one or more hierarchies are arranged for different purposes, but are intended to include the same concepts, they may be tied into a duplication set to simplify taxonomy administration. In FIG. 9, the window 204 shows an example duplication set 902 entitled “test1” which includes the four metric hierarchies shown at 904. The user may add or remove hierarchies to the duplication set 902 by selecting and dragging to or from the indication of the duplication set 902. For example, hierarchies may be selected from window 906. It will be appreciated that a duplication set of entity hierarchies could also be created. According to various embodiments, the interface 200 may include an indication of which concepts and/or hierarchy branches form part of a duplication set. For example, metric 906 “Operating Expense” is marked with a “D” indicating that it is part of the duplication set 902. Metric 908 “Interest expense, net” is not similarly marked, indicating that it is not part of the duplication set 902. It will be appreciated that any suitable indication may be used.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for processing data for standalone application and/or over a networked medium or media. Computers and computer systems disclosed herein may include operatively associated memory for storing certain software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, ROM (read only memory), RAM (random access memory), PROM (programmable ROM), EEPROM (extended erasable PROM), and/or other like computer-readable media.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention.

We claim:

1. A system for describing information, the system comprising at least one processor configured to:
receive a taxonomy, wherein the taxonomy comprises a metric hierarchy and a plurality of entity hierarchies;
display an indication of a metric selected from the metric hierarchy; and
display a representation of at least a portion of a second hierarchy selected from the plurality of entity hierarchies, wherein the representation comprises an indication of a branch of the second hierarchy and an indication of a relationship between the branch of the second hierarchy and the metric.

2. The system of claim 1, wherein the relationship between the branch of the second hierarchy indicates that each instance of the branch is required to be described by an instance of the metric concept.

3. The system of claim 1, wherein the relationship between the branch of the second hierarchy indicates that each instance of the branch is permitted to be described by an instance of the metric concept.

4. The system of claim 1, wherein the relationship between the branch of the second hierarchy indicates that no instance of the branch is permitted to be described by an instance of the metric concept.

5. The system of claim 1, wherein the branch of the second hierarchy comprises one entity concept.

6. The system of claim 1, wherein the at least one processor is further configured to display a representation of at least a portion of a third hierarchy selected from the plurality of entity hierarchies, wherein the representation comprises an indication of a branch of the third hierarchy and an indication of a relationship between the branch of the third hierarchy and the metric.

7. The system of claim 1, wherein the indication of the metric and the representation of at least the portion of the second hierarchy are displayed simultaneously.

8. The system of claim 1, wherein the at least one processor is further configured receive an instruction from a user indicating the relationship between the branch of the second hierarchy and the metric.

9. The system of claim 1, wherein the second hierarchy is a hierarchy of a class of entities selected from the group consisting of companies, countries, employees, industries, exchanges, indices, legal entities, securities, and regions.

10. The system of claim 1, wherein the at least one processor is further configured to modify the relationship between the branch of the second hierarchy and the metric.

11. The system of claim 10, wherein the modification is applied to all entities included in the branch of the second hierarchy.

12. A computer readable medium having instructions thereon that when executed by at least one processor cause the at least one processor to:
receive a taxonomy, wherein the taxonomy comprises a metric hierarchy and a plurality of entity hierarchies;
display an indication of a metric selected from the metric hierarchy; and
display a representation of at least a portion of a second hierarchy selected from the plurality of entity hierarchies, wherein the representation comprises an indication of a branch of the second hierarchy and an indication of a relationship between the branch of the second hierarchy and the metric.

13. A system for describing information, the system comprising at least one processor configured to:
receive a taxonomy, wherein the taxonomy comprises a plurality of hierarchies;
tie a first branch selected from a first hierarchy to a second branch selected from the second hierarchy, wherein the first and second hierarchies are selected from the plurality of hierarchies;
receive an instruction to modify a portion of the first branch;
modify the portion of the first branch in response to the instruction; and
modify a duplicate of the portion of the first branch within the second branch in response to the instruction.

14. The system of claim 13, wherein the first hierarchy consists of metrics.

15. The system of claim 13, wherein the first hierarchy consists of entities.

16. The system of claim 13, wherein the at least one processor is further configured to display a representation of the first branch, wherein the representation comprises an indication that the portion of the first branch is tied to another portion.

17. The system of claim 13, wherein the at least one processor is further configured to receive an instruction to tie the first branch to the second branch.

18. The system of claim 13, wherein the first branch comprises a single entity.

19. The system of claim 13, wherein the first branch comprises a single metric.

20. The system of claim 13, wherein tying the first branch to the second branch comprises tying the first hierarchy to the second hierarchy.

21. A computer readable medium having instructions thereon that when executed by at least one processor, cause the at least one processor to:
receive a taxonomy, wherein the taxonomy comprises a plurality of hierarchies;
tie a first branch selected from a first hierarchy to a second branch selected from the second hierarchy, wherein the first and second hierarchies are selected from the plurality of hierarchies;
receive an instruction to modify a portion of the first branch;
modify the portion of the first branch in response to the instruction; and
modify a duplicate of the portion of the first branch within the second branch in response to the instruction.

22. A system for describing information, the system comprising at least one processor configured to:
receive a taxonomy, wherein the taxonomy comprises a first hierarchy comprising concepts of a first concept type and a second hierarchy comprising concepts of a second concept type;
display an indication of a first concept selected from the first hierarchy; and
display a representation of at least a portion of a second hierarchy, wherein the representation comprises an indication of a branch of the second hierarchy and an indication of a relationship between the branch of the second hierarchy and the first concept.

23. The system of claim 22, wherein the branch of the second hierarchy comprises one concept.

24. The system of claim 22, wherein the at least one processor is further configured to display a representation of at least a portion of a third hierarchy, wherein the representation comprises an indication of a branch of the third hierarchy and an indication of a relationship between the branch of the third hierarchy and the first concept.

25. The system of claim 22, wherein the first concept type is selected from the group consisting of a metric concept type, an entity concept type, a source concept type, and a time concept type.
